(19) United States
(12) Patent Application Publication
(10) Pub. No.: US 2026/0099282 A1
(43) Pub. Date: Apr. 9, 2026

(54) INFORMATION PROCESSING APPARATUS, PRINTING SYSTEM, AND PRINTING METHOD

(71) Applicant: SEIKO EPSON CORPORATION, Tokyo (JP)

(72) Inventors: Takumi YOSHIDA, Hara-mura (JP); Akinobu MIKOSHIBA, Matsumoto (JP)

(21) Appl. No.: 19/350,095

(22) Filed: Oct. 6, 2025

(30) Foreign Application Priority Data
Oct. 8, 2024 (JP) 2024-176257

(51) Int. Cl. G06F 3/12; G06Q 20/14

(52) U.S. Cl. CPC G06F 3/1222; G06F 3/1238; G06F 3/126; G06F 3/1292; G06Q 20/14

(57) ABSTRACT

An information processing apparatus includes an authenticator configured to perform user authentication; an authorizer configured to present, to an authenticated user, one or more printing apparatuses associated with the authenticated user, and to, when the authenticated user authorizes printing to be performed by the presented printing apparatus, acquire authorization information corresponding to the printing apparatus; and a print controller configured to request the printing apparatus corresponding to the authorization information to perform printing requested using the authorization information, and not to request the printing apparatus to perform printing requested without using the authorization information.

The present application is based on, and claims priority from JP Application Serial Number 2024-176257, filed October 8, 2024, the disclosure of which is hereby incorporated by reference herein in its entirety.

### BACKGROUND

1. Technical Field

The present disclosure relates to an information processing apparatus, a printing system, and a printing method.

### 2. Related Art

In the related art, for example, as described in JP-A-2012-133489, there is known a cloud printing service in which a printer is caused to perform printing from client terminals via a cloud server.

It is desirable to improve security in a cloud printing service.

### SUMMARY

According to an aspect of the present disclosure, an information processing apparatus includes an authenticator configured to perform user authentication; an authorizer configured to present, to an authenticated user, one or more printing apparatuses associated with the authenticated user, and to, when the authenticated user authorizes printing to be performed by the presented printing apparatus, acquire authorization information corresponding to the printing apparatus; and a print controller configured to request the printing apparatus corresponding to the authorization information to perform printing requested using the authorization information, and not to request the printing apparatus to perform printing requested without using the authorization information.

According to an aspect of the present disclosure, a printing system includes information processing apparatus and a printing apparatus. The information processing apparatus includes an authenticator configured to perform user authentication, an authorizer configured to present, to an authenticated user, the printing apparatus associated with the authenticated user, and to, when the authenticated user authorizes printing using the presented printing apparatus, acquire authorization information corresponding to the printing apparatus, and a print controller configured to request the printing apparatus corresponding to the authorization information to perform printing requested using the authorization information, and not to request the printing apparatus to perform printing requested without using the authorization information. The printing apparatus performs printing requested by the information processing apparatus.

According to an aspect of the present disclosure, a printing method includes performing user authentication; presenting, to an authenticated user, a printing apparatus associated with the authenticated user, and, when the authenticated user authorizes printing using the presented printing apparatus, acquiring authorization information corresponding to the printing apparatus; and requesting the printing apparatus corresponding to the authorization information to perform printing requested using the authorization information, and not requesting the printing apparatus to perform printing requested without using the authorization information.

### BRIEF DESCRIPTION OF THE DRAWINGS

FIG. 1 is a block diagram illustrating the configuration of a printing system.

FIG. 2 is a table depicting an example of printer information stored in an information processing apparatus.

FIG. 3 is a sequence diagram illustrating an example of an authorization sequence.

FIG. 4 depicts an example of screen transitions in a terminal.

### DESCRIPTION OF EMBODIMENTS

Embodiments of the present disclosure will be described here in the following order.

1. Configuration of Printing System

1-1 Configuration of Printer

1-2 Configuration of Server

2. Authorization Sequence

3. Other Embodiments

1. Configuration of Printing System

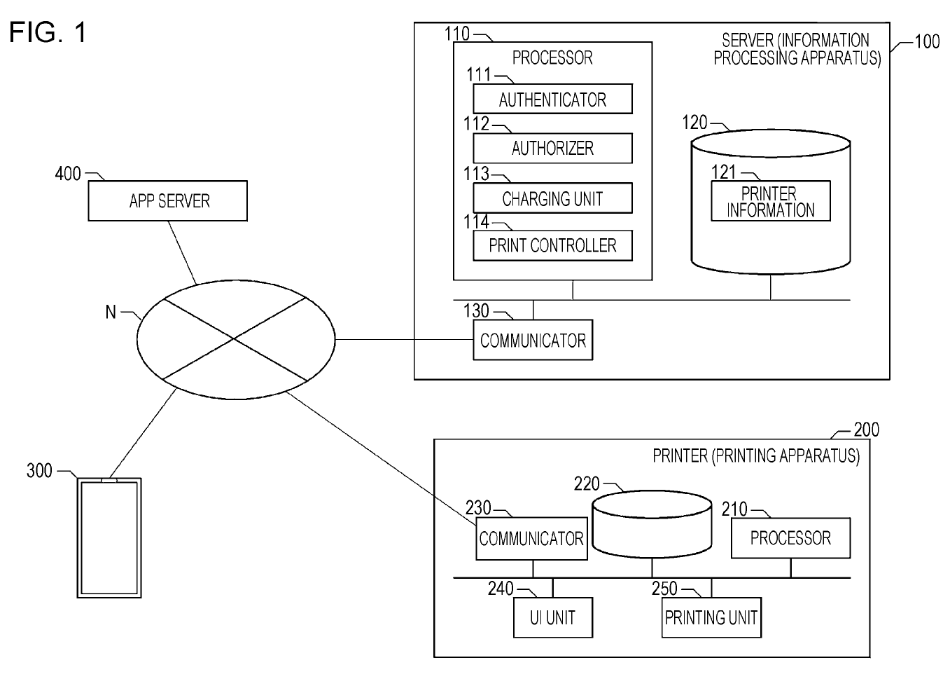

FIG. 1 is a block diagram illustrating an overall configuration including a printing system according to an embodiment of the present disclosure. The printing system includes a server 100 as an information processing apparatus and a printer 200 as a printing apparatus. The server 100 provides a printing service that enables a specified printer to print printing data via the server 100, that is, a cloud printing service. The server 100 is capable of communicating with the printer 200, which is available for the cloud printing service, over a network N such as the Internet.

In the present embodiment, a terminal 300 is operated by a user who owns the printer 200. The terminal 300 is capable of communicating with the server 100 over the network N. The terminal 300 is a smartphone, personal computer (PC), tablet, or the like. The terminal 300 includes a communicator for communicating with other devices, a user interface (UI) unit that displays various types of information to the user and receives various types of user operations, a nonvolatile memory that stores various types of programs and data, a processor, and other components.

The terminal 300 is capable of communicating with an application (app) server 400, the server 100, and other devices over the network N. The user uses the terminal 300 to perform user registration for the cloud printing service, register a printer used in the cloud printing service, and perform other related operations. The user may own a plurality of printers available for the cloud printing service. FIG. 1 illustrates one of the printers.

The app server 400 provides various services using the cloud printing service. One example of such services using the cloud printing service may be a content delivery service. The content delivery service using the cloud printing service is a service in which the printer 200, owned by the user, prints various contents from the app server 400. A more specific example of such a service may be one in which, for example, a company that creates newspaper page data allows the newspaper page data to be printed on a printer owned by a newspaper subscriber. Alternatively, a service may involve a cram school or a learning content creation company allowing exercise data for a student to be printed on a printer owned by the student.

To use such a content delivery service based on the cloud printing service, the user registers in advance with the server 100 as a user of the cloud printing service. During registration for the cloud printing service, the user registers user identification information, a password, and the identification information of a printer owned by the user. The user identification information as used here is, for example, an email address. If user registration for the content delivery service is needed, the user also registers in advance with the app server 400.

### 1-1 Configuration of Printer

In the present embodiment, the printer 200 is a printing apparatus that performs printing on a print medium in response to a print request from the server 100. The printer 200 includes a processor 210, a storage medium 220, a communicator 230, a UI unit 240, and a printing unit 250. The printer 200 also includes a random access memory (RAM) and a read-only memory (ROM) (not illustrated). The processor 210 controls the printer 200 by executing various programs stored in the ROM, the storage medium 220, and the like. The processor 210 may be implemented on a single chip or may be distributed across multiple chips. In addition, in the present embodiment, the processor 210 is a central processing unit (CPU), but it may be implemented as an application-specific integrated circuit (ASIC) or the like, or may include both a CPU and an ASIC. When other devices in the present embodiment include a processor, the processor is implementable in various forms, as with the processor 210.

The storage medium 220 stores various programs, such as a control program for controlling printing, and printing data transmitted from the server 100. The communicator 230 includes circuitry used for communication with other devices using various wired or wireless communication protocols. The UI unit 240 includes a touch panel display, keys, and other components for displaying various types of information to the user and receiving user input.

The printing unit 250 includes actuators, driving components, mechanical parts, sensors, and other elements that perform printing by ejecting ink onto a print medium. The processor 210 performs printing by controlling the printing unit 250 based on the printing data.

### 1-2 Server Configuration

The server 100 includes a processor 110, a storage medium 120, and a communicator 130. The processor 110, which is a CPU provided with a RAM, a ROM, and other components, is capable of executing various programs stored in the storage medium 120. The programs executable by the processor 110 include a cloud print control program that implements the cloud printing service.

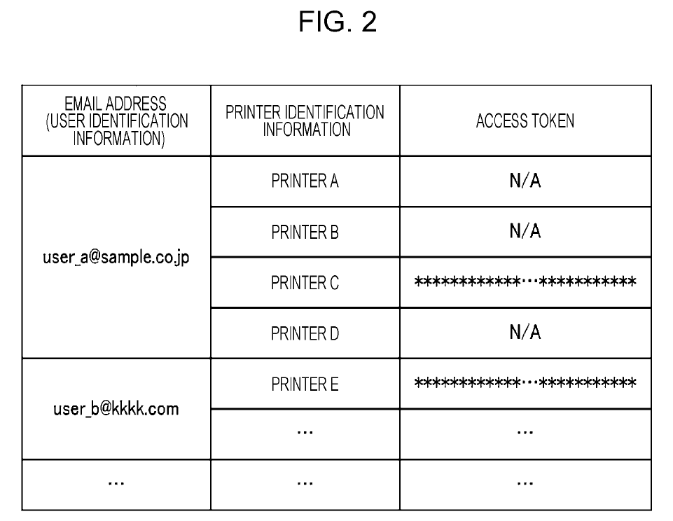

The storage medium 120 stores the cloud print control program (not shown) and printer information 121. As depicted in FIG. 2, in the printer information 121, an email address as identification information of the user is associated with the identification information of a printer owned by the user. Additionally, if an access token (described later) has been issued for a printer, the access token is stored in association with the identification information of the printer.

The communicator 130 includes a communication interface for communicating with other devices based on various communication protocols. The server 100 is capable of communicating with the app server 400, the terminal 300, and the printer 200 via the communicator 130. Additionally, the server 100 is also capable of communicating with devices such as a keyboard, mouse, and display via the communicator 130.

In the content delivery service using the cloud printing service, the app server 400 issues a print request to the printer 200 of the user via the server 100. The app server 400 sends a print request using a web API published by the server 100. When the user who owns the printer 200 authorizes the app server 400 to send a print request to the printer 200 owned by the user, the server 100 issues authorization information to the app server 400. In the present embodiment, the authorization information is an access token. The access token is information generated to uniquely identify a printer and is, for example, a random combination of alphanumeric characters. However, the access token is generated separately from the identification information of the printer. The access token is assigned to the app server that has been authorized to cause the printer of the user to perform printing. When using the web API to issue a print request, the app server 400 specifies the access token and the printing data. The server 100 identifies the printer associated with the access token and causes the identified printer to print the printing data. To implement these functions, the processor 110 of the server 100 executes the cloud print control program.

By executing the cloud print control program, the processor 110 functions as an authenticator 111, an authorizer 112, a charging unit 113, and a print controller 114. The processor 110 functions as the authenticator 111 to perform user authentication. That is, the processor 110 performs authentication processing to determine whether a user attempting to register a printer for use in the cloud printing service is a valid user who has completed the user registration. In the present embodiment, the email address of the user and whose password are managed by an ID provider (not shown). Therefore, the server 100 requests the ID provider to perform the user authentication processing. Note that in the present embodiment, the server 100 cooperates with the app server 400, the ID provider (not shown), and a charging platform (not shown), which will be described later. The device that transmits and receives various types of data to and from the terminal 300 operated by the user varies among the app server 400, the server 100, the ID provider, and the charging platform, depending on the processing content. Here, the various types of data refer to screen display data as well as data indicating the input and operation content by the user.

When the user authentication is successful, the processor 110 functions as the authorizer 112 to present the authenticated user with the printers associated with the user and to, if the user authorizes printing with a presented printer, acquire an access token corresponding to that printer. In the present embodiment, the processor 110 identifies printers associated with the identification information of the authenticated user by referring to the printer information 121 (see FIG. 2). The processor 110 causes the terminal operated by the user to display a list of the identified printers, and acquires the access token corresponding to the printer selected from the list by the user. The processor 110 causes the terminal 300 to display a printer selection screen that lists the identification information of the printers owned by the user, that is, the identification information of the printers stored in association with the email address of the user as the identification information, and that allows the user to select one of the listed items. When the user selects a printer to be used in the cloud printing service from among the printers displayed in the list, the processor 110 acquires the identification information of the selected printer from the terminal 300. Upon acquiring the identification information of the printer selected by the user, the processor 110 considers that the user has authorized the use of the selected printer for the cloud printing service. Thus, according to the present embodiment, the user can select a printer to be used in the cloud printing service from among a plurality of printers owned by the user.

The server 100 charges a usage fee for the cloud printing service to the user who owns the printer. Specifically, if the user authorizes printing in the cloud printing service using the printer 200, the processor 110 functions as the charging unit 113 to perform preparation processing for charging a usage fee to the user. This charging preparation processing sets conditions under which the usage fee can be charged to the user at a predetermined time, and includes explaining the usage fee, acquiring payment information from the user for payment, performing authentication of the payment information, and other related operations. The payment information is used for processing payment according to the payment method selected by the user. For example, when payment by a credit card is selected, the payment information includes a credit card number, a card holder name, an expiration date, a security code, and so on. In the present embodiment, the server 100 requests the charging platform (not shown) to perform the charging preparation processing. In the present embodiment, the charging platform is a server that executes the charging preparation processing and performs the actual charge based on payment information at a predetermined time after the preparation processing. Once the charging preparation processing is complete, the processor 110 functions as the authorizer 112 to acquire an access token and to pass it to the app server 400. In this way, it is possible to prevent the access token from being acquired and transmitted to the app server 400 before the charging preparation processing is complete.

For example, in the case of a subscription contract, a fixed usage fee is charged to the user every month at a predetermined time, based on the payment information of the user, by the charging platform. The method of charging the usage fee for the cloud printing service is not limited to the subscription form and may take various forms. Charging may be done per use, or may be performed on a pay-per-use basis according to the amount of printing during each predetermined period.

Here, the predetermined period may be one month, for example, but other periods may be used. Additionally, examples of the amount of printing includes the number of printed cut sheets, the printed length of roll paper, and the size of printing data.

When the charging preparation processing is performed, as described above, the processor 110 generates an access token, and stores it, in the storage medium 120, in association with the identification information of the printer selected by the user. The processor 110 also transmits the access token to the app server 400. After acquiring the access token, when issuing a print request to the server 100 to print the printing data using the printer of the user, the app server 400 includes the access token in the web API used for the print request provided by the server 100. That is, the app server 400 transmits both the print request and the access token to the server 100.

The processor 110 functions as the print controller 114 to request a printer corresponding to the access token to perform printing requested using the access token, and not to request the printer to perform printing requested without using the access token. That is, the processor 110 compares data specified as the access token in the web API with the access token stored in the storage medium 120, and identifies the printer corresponding to the matched access tokens. The processor 110 then converts the printing data into a format suitable for printing the printing data by the specified printer, and transmits the converted printing data to the printer to request printing. Upon receiving the request, the printer performs printing based on the printing data. If the data specified as the access token in the web API for the print request does not match the access token stored in the storage medium 120, the processor 110 does not request any printer to perform the printing based on the print request.

As described above, according to the present embodiment, an access token corresponding to the printer authorized by the authenticated user is acquired. The server 100 causes the printer to perform printing in response to a print request using the access token acquired in this way, and does not cause the printer to perform printing in response to a print request not using the access token. Therefore, it is possible to prevent the printer from performing printing in response to a print request from a third party unable to use the access token described above. This enables improvement in the security of the cloud printing service.

The processor 110 also functions as the authorizer 112 to acquire location information indicating the location of the user. When the location information indicates a predetermined region, the processor 110 functions as the charging unit 113 to perform the charging preparation processing. In the present embodiment, the IP address of a device (access source) accessing the server 100 is used as the location information. Additionally, the predetermined region is one that the server 100 has determined in advance as a charging target region. The processor 110 identifies the region where the user terminal 300 is located, based on the IP address of the access source. When the region of the terminal of the user is a predetermined region, which is determined in advance as a charging target region, the processor 110 performs charging preparation processing and acquires the access token after completion of this preparation processing. In contrast, if the location information does not indicate the predetermined region, the processor 110 acquires the access token without performing the charging preparation processing. In this way, the server 100 can perform printing using the access token after completion of the charging preparation processing when the user is in the charging target region. In addition, the server 100 can perform printing using the access token without the charging preparation processing, that is, free printing when the user is not in the charging target region.

The region as used here refers to a country. However, the region is not limited to a country and may also be a region including a plurality of countries or a subnational region, such as an administrative district, within a country.

### 2. Authorization Sequence

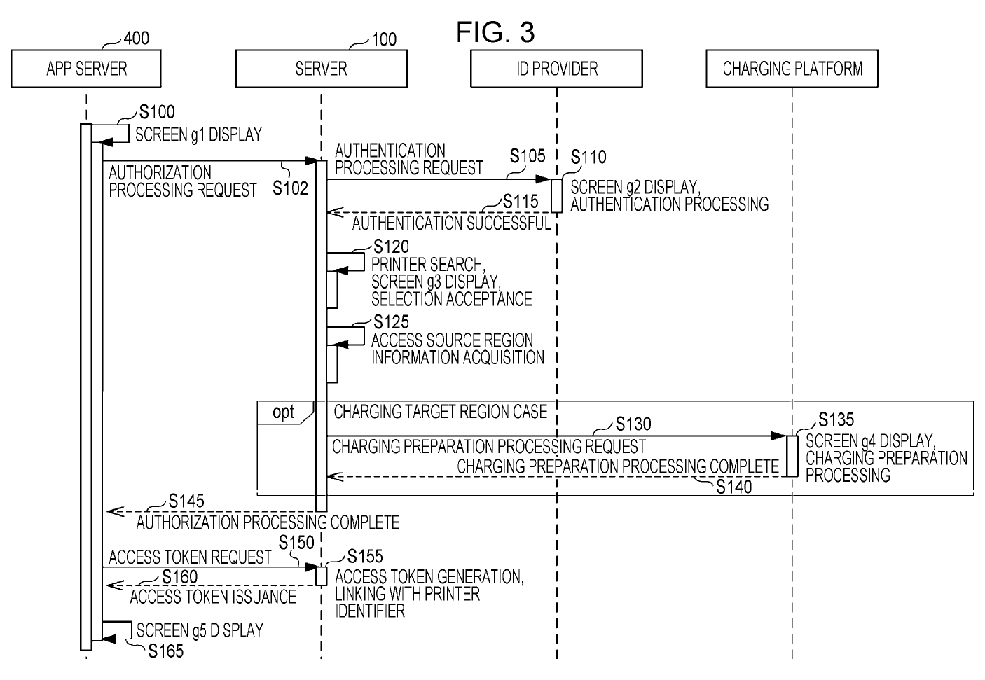

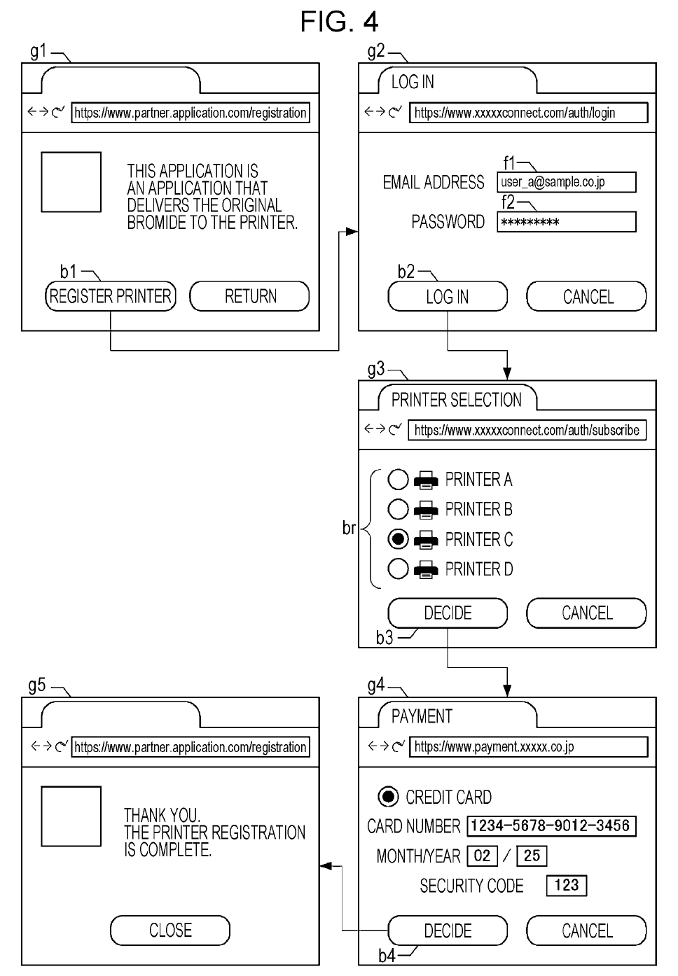

FIG. 3 is a sequence diagram illustrating an example of a schematic sequence in which a user authorizes printing on the printer 200 owned by the user through an application provided by the app server 400. FIG. 4 depicts an example of schematic screen transitions on the terminal 300 in the sequence illustrated in FIG. 3.

A screen g1 is an example of a screen prompting printer registration in the cloud printing service provided by the server 100 in the content delivery service offered by the app server 400. The screen g1 is displayed on the terminal 300 based on display data generated by the app server 400.

The app server 400 transmits the display data of the screen g1 to the terminal 300 to prompt printer registration for cooperation with the cloud printing service, thereby causing the terminal 300 to display the screen g1 (step S100). When a printer registration button b1 is pressed on the screen g1, the terminal 300 transmits, to the app server 400, information indicating the press of the printer registration button b1. Upon receiving this information, the app server 400 transmits an authorization processing request to the server 100 (step S102). When the authorization processing request is obtained from the app server 400, the processor 110 of the server 100 functions as the authenticator 111 to transmit a request for authentication processing to the ID provider (step S105). Upon obtaining the authentication processing request, the ID provider causes the terminal 300 to display a login screen as shown in a screen g2, and performs the authentication processing (step S110). That is, the ID provider transmits display data for displaying the screen g2 to the terminal 300. Upon receiving the display data, the terminal 300 displays the screen g2.

The screen g2 includes an email address input section f1, a password input section f2, and a login button b2. When the user inputs the email address and password registered during user registration for the cloud printing service into the email address input section f1 and the password input section f2, respectively, and presses the login button b2, the terminal 300 transmits the input email address and password to the ID provider. The ID provider compares the email address and password transmitted from the terminal 300 with the combination of the mail address and password stored in the storage medium and performs user authentication. If the authentication is successful, the ID provider notifies the server 100 of the successful authentication (step S115).

When the notification of the successful authentication is obtained, the processor 110 functions as the authorizer 112 to search for a printer owned by the user, to display the screen g3, and to receive the selection of the printer (step S120). That is, with reference to the printer information 121 (see FIG. 2), the processor 110 identifies the printer associated with the user successfully authenticated in step S115. The processor 110 transmits display data to the terminal 300 to display the printer selection screen g3, including information indicating the identified printer.

The screen g3 includes a list of printers associated with the authenticated user, radio buttons br corresponding to the respective printers, and a decision button b3. When the user selects one of the printers from the printer list by operating the radio button br and presses the decision button b3, the terminal 300 transmits information indicating the selected printer to the server 100. The screen g3 in FIG. 4 shows that the printer C is selected.

When the information indicating the selected printer is acquired, the processor 110 functions as the authorizer 112 to acquire the region information of the access source, that is, the location information (step S125). That is, the processor 110 acquires, as the location information of the user, the access source information, such as an IP address, which is used when the terminal 300 communicates with the server 100. If the access source is in the charging target region, that is, if the access source corresponds to a predetermined region, the processor 110 transmits a charging preparation processing request to the charging platform (step S130). Note that, prior to S130, the processor 110 may cause the terminal 300 of the user to display an explanation of contract terms, such as the fee and charging date, and, upon obtaining the approval of the user from the terminal 300, may proceed with the processing of step S130.

Upon obtaining the request for charging preparation processing, the charging platform performs charging preparation processing (step S135). That is, the charging platform transmits display data for displaying a screen g4 to the terminal 300. The screen g4 includes a selection button for a payment method, an input section for payment information, and a decision button b4. In the example of the screen g4, a credit card is selected as a payment method, and a card number, an expiration date, and a security code are input. When the decision button b4 on the screen g4 is selected, the terminal 300 transmits these items of information to the charging platform. The charging platform authenticates the transmitted payment information of the user, stores the payment information in a storage medium, and notifies the server 100 that the charging preparation processing is complete (step S140).

If the area information of the access source acquired in step S125 does not indicate the charging target region, steps S130 to S140 are skipped. Therefore, after completion of step S125 or after completion of step S140, the processor 110 functions as the authorizer 112 to notify the app server 400 of completion of the authorization processing (step S145).

When the notification of completion of the authorization processing is obtained, the app server 400 transmits an access token request corresponding to the authorized printer to the server 100 (step S150). When the access token request is received, the processor 110 of the server 100 functions as the authorizer 112 to generate an access token of the authorized printer, and stores the access token in association with the identification information of the printer in the storage medium 120 (step S155). Then, the processor 110 transmits the generated access token to the app server 400 (step S160). Upon receiving the access token from the server 100, the app server 400 transmits the display data of the screen g5 to the terminal 300, and causes the terminal 300 to display the screen g5 (step S165).

As described above, the server 100 can issue, to the app server 400, an access token associated with an individual printer authorized by the user to be used in the cloud printing service. The app server 400 stores the issued access token in association with the user. In step S160, a refresh token used for refreshing the access token may also be issued. In this case, the refresh token, together with the access token, is stored in association with the user in the app server 400.

When transmitting a print request to a printer owned by the user using a web API, the app server 400 specifies the access token of the printer, printing data to be printed, and print settings. The processor 110 of the server 100 identifies a printer stored in association with the specified access token in the storage medium 120. If the printer associated with the specified access token is successfully identified, the processor 110 functions as the print controller 114 to convert printing data in order to print the printing data according to the print settings on the identified printer, and to transmit a print request of the converted printing data to the printer 200.

The processor 210 of the printer 200 performs printing by controlling the printing unit 250 based on the printing data acquired from the server 100. Upon completion of the printing, the printer 200 transmits a printing completion notification to the server 100. When the print completion notification is obtained from the printer 200, the server 100 transmits the print completion notification to the app server 400.

If the printer associated with the access token specified by the app server 400 fails to be identified, the processor 110 functions as the print controller 114 not to transmit a print request of the printing data to any printer. Therefore, printing is not performed by the printer of the user in response to a print request from the app server 400.

### 3. Other Embodiments

The above embodiment is an example for implementing the present disclosure, and various other embodiments may be adopted. For example, the server 100 may be comprised of a plurality of server computers, and, for example, each of the authenticator 111, the authorizer 112, the charging unit 113, and the print controller 114 may be implemented by a separate server computer. In addition, the processing performed by the ID provider or the charging platform in the embodiment described above may be performed by the server 100. Furthermore, for example, in the embodiment described above, the access token is generated in the server 100. However, the server 100 may request another server to generate the access token and may acquire the generated access token.

In the embodiment described above, the app server 400 is run by a user different from the user who owns the printer 200. However, the printer 200 may be a printer owned by a user who operates the app server 400.

In addition, in the embodiment described above, the selection of the printer to be used in the cloud printing service is performed one by one. However, when a plurality of printers are owned by the user, the plurality of printers may be selected at once. In the case where a usage fee is charged for each printer used in the cloud printing service, charging preparation processing for a plurality of selected printers may be performed collectively. In addition, even if the charging preparation processing is collectively performed for a plurality of printers, a different access token is associated with each printer.

In addition, the sequence and the screen transition described in the embodiment described above are merely exemplary, and various transitions other than these examples may be assumed. For example, in the case of charging on a pay-per-use basis, after user authentication via a login screen as shown in the screen g2 in FIG. 4 and before selection of a printer for which an access token is to be issued, the screen may transition to a screen on which payment information is input as charging preparation processing.

The authorizer may be configured to, in response to obtaining a request from the authenticated user to cancel authorization for the printing apparatus, invalidate the authorization information corresponding to the printing apparatus. That is, the processor may provide a user interface for canceling the use in the cloud printing service to the printer that the user has permitted to be used in the cloud printing service. Specifically, for example, when user authentication to the server is performed, the server causes a list of printers owned by the user to be displayed on the terminal of the user, and causes an authorization cancel button to be displayed for an authorized printer. When information indicating that the user has operated the authorization cancel button of the printer for which authorization is to be cancelled is acquired from the terminal, the processor discards the access token stored in association with the printer in the storage medium. Accordingly, a print request using authorization information may be prevented from being made to a printer that the user does not intend to use in the cloud printing service. In addition, the authorization information may be prevented from being fraudulently invalidated by a person other than the legitimate user who owns the printer.

Note that the authorization information may be information that is given to an application that has been authorized to cause the printing apparatus of a user to perform printing and that is information that enables the information processing apparatus to uniquely identify the printing apparatus of the user. The present disclosure is not limited to the use of the mechanism of the access token if the above is implementable.

In FIG. 2, the identification information of the printer and the access token are managed in association with each other; however, information on a destination to which an access token is issued, such as an application or identification information of an App server, may also be associated and stored. In addition, in the case where the user authorizes printing by a plurality of different app servers or applications for one printer, a different access token is generated and stored for each app server or application in association with the identification information of the printer. For example, for a certain printer, even in the case where an access token has already been issued to a first application and is valid, if the user permits a second application to cause the printer to perform printing, an access token is issued to the second application unless a valid access token for the second application is stored in association with the printer.

Furthermore, the present disclosure is applicable to a printing system including the information processing apparatus and printing apparatus described above. The present disclosure is also applicable to a program and printing method executed by a computer. The printing method includes performing user authentication; presenting, to an authenticated user, a printing apparatus associated with the authenticated user, and to, when the authenticated user authorizes printing to be performed by the presented printing apparatus, acquire authorization information corresponding to the printing apparatus; and requesting the printing apparatus corresponding to the authorization information to perform printing requested using the authorization information, and not requesting the printing apparatus to perform printing requested without using the authorization information.

In addition, the system, program, and method mentioned above may be implemented as a single device or may be implemented using components included in a plurality of devices, and various forms thereof are included. In addition, the configuration may be appropriately changed such that a portion of the configuration is software and a portion of the configuration is hardware. In addition, the disclosure is also implemented as a recording medium for a program for controlling the system. Undoubtedly, the recording medium for the program may be a magnetic recording medium or a semiconductor memory, and the same may be applied to any recording medium to be developed in the future.

What is claimed is:

1. An information processing apparatus comprising:
an authenticator configured to perform user authentication;
an authorizer configured to present, to an authenticated user, one or more printing apparatuses associated with the authenticated user, and to, when the authenticated user authorizes printing to be performed by the presented printing apparatus, acquire authorization information corresponding to the printing apparatus; and
a print controller configured to request the printing apparatus corresponding to the authorization information to perform printing requested using the authorization information, and not to request the printing apparatus to perform printing requested without using the authorization information.

2. The information processing apparatus according to claim 1, wherein
the authorizer is configured to
cause a terminal operated by the authenticated user to display a list of the printing apparatuses associated with the authenticated user, and
acquire the authorization information corresponding to the printing apparatus selected from among the list by the user.

3. The information processing apparatus according to claim 1, wherein
the authorizer is configured to, in response to obtaining a request from the authenticated user to cancel authorization for the printing apparatus, invalidate the authorization information corresponding to the printing apparatus.

4. The information processing apparatus according to claim 1, further comprising:
a charging unit configured to, when the authenticated user authorizes printing to be performed by the printing apparatus, perform preparation processing for charging the authenticated user a usage fee of a printing service that causes the printing apparatus to print printing data via an information processing apparatus, wherein
the authorizer is configured to, when the preparation processing is performed, acquire the authorization information.

5. The information processing apparatus according to claim 4, wherein
the authorizer is configured to acquire address information indicating an address of the authenticated user, and
the charging unit is configured to, when the location information indicates a predetermined region, perform the preparation processing.

6. The information processing apparatus according to claim 4, wherein
the authorizer is configured to acquire address information indicating an address of the authenticated user, and to, when the location information does not indicate a predetermined region, acquire the authorization information without performing the preparation processing.

7. A printing system comprising an information processing apparatus and a printing apparatus, wherein
the information processing apparatus includes
an authenticator configured to perform user authentication,
an authorizer configured to present, to an authenticated user, the printing apparatus associated with the authenticated user, and to, when the authenticated user authorizes printing using the presented printing apparatus, acquire authorization information corresponding to the printing apparatus, and
a print controller configured to request the printing apparatus corresponding to the authorization information to perform printing requested using the authorization information, and not to request the printing apparatus to perform printing requested without using the authorization information, and
the printing apparatus performs printing requested by the information processing apparatus.

8. A printing method comprising:
performing user authentication;
presenting, to an authenticated user, a printing apparatus associated with the authenticated user, and, when the authenticated user authorizes printing using the presented printing apparatus, acquiring authorization information corresponding to the printing apparatus; and
requesting the printing apparatus corresponding to the authorization information to perform printing requested using the authorization information and not requesting the printing apparatus to perform printing requested without using the authorization information.
